(19) United States
(12) Patent Application Publication
(10) Pub. No.: US 2012/0068568 A1
(43) Pub. Date: Mar. 22, 2012

(54) Axial Winding Motor

(76) Inventors: Alex Horng, Kaohsiung (TW); Yen-Ming Chen, Kaohsiung (TW); Chung-Ken Cheng, Kaohsiung (TW)

(21) Appl. No.: 12/938,469

(22) Filed: Nov. 3, 2010

(30) Foreign Application Priority Data
Sep. 21, 2010 (TW) 099132103

(51) Int. Cl. H02K 1/27

(52) U.S. Cl. 310/156.47

(57) ABSTRACT

An axial-winding motor includes a stator and a rotor. The stator has a winding assembly, a first magnetic-conducting plate and a second magnetic-conducting plate. The first and second magnetic-conducting plates are coupled with two ends of the winding assembly in an axial direction of the winding assembly. The first magnetic-conducting plate includes a plurality of first pole pieces on an outer periphery thereof, and the second magnetic-conducting plate includes a plurality of second pole pieces on an outer periphery thereof. The rotor is rotatably coupled with the stator and has a plurality of magnetic pole faces facing the stator. One of the first pole pieces is at least partially overlapped with adjacent one of the second pole pieces in an axial direction of the stator.

### BACKGROUND OF THE INVENTION

1. Field of the Invention

The present invention generally relates to an axial-winding motor and, more particularly, to an axial-winding motor that has low axial vibration.

2. Description of the Related Art

Referring to FIGS. 1 to 3, a conventional axial-winding motor including a stator 8 and a rotor 9 is shown. The stator 8 receives currents and generates magnetic forces. The rotor 9 is disposed in accordance with the stator 8 and may be driven to rotate by the magnetic forces generated by the stator 8.

Specifically, the stator 8 includes a winding assembly 81, a first magnetic-conducting plate 82 and a second magnetic-conducting plate 83. The winding assembly 81 includes a winding 811 extending in an axial direction of the stator 8. The first magnetic-conducting plate 82 is disposed on one end of the winding assembly 81 in the axial direction and includes two pole pieces 821 and two excitation faces 822. The pole pieces 821 are located on a periphery of the first magnetic-conducting plate 82. Each excitation face 822 is located on a respective pole piece 821 and faces outwards. The second magnetic-conducting plate 83 is disposed on the other end of the winding assembly 81 in the axial direction and includes two pole pieces 831 and two excitation faces 832. The pole pieces 831 are located on a periphery of the second magnetic-conducting plate 83. Each excitation face 832 is located on a respective pole piece 831 and faces outwards. Either of the pole pieces 821 of the first magnetic-conducting plate 82 is not overlapped with either pole piece 831 of the second magnetic-conducting plate 83 in the axial direction of the stator 8. The rotor 9 includes an annular magnet 91 extending along an outer periphery of the stator 8. The annular magnet 91 includes a plurality of magnetic pole faces 911 facing the stator 8. The magnetic pole faces 911 are a plurality of N and S pole faces arranged in an interlaced manner, as shown in FIG. 3. Based on this, when a current is input into the winding 811, the excitation faces 822 and 832 of the first magnetic-conducting plate 82 and the second magnetic-conducting plate 83 will generate two N poles and two S poles (namely, the two excitation faces 822 are N poles and the two excitation faces 832 are S poles, or the two excitation faces 822 are S poles and the two excitation faces 832 are N poles). Thus, the two N poles and two S poles will repel the magnetic pole faces 911 of the annular magnet 91, thereby driving the rotor 9 to rotate.

In the above axial-winding motor, the first magnetic-conducting plate 82 and the second magnetic-conducting plate 83 are located on two axial ends of the winding assembly 81, and the excitation faces 822 and 832 are arranged on the outer periphery of the stator 8 in the interlaced manner. Based on this, when the excitation faces 822 and 832 are excited to generate the two N poles and the two S poles, the two N poles will repel one axial end of the annular magnet 91 and the two S poles will repel the other axial end of the annular magnet 91. Thus, larger axial vibration of the rotor 9 is easily resulted during rotation thereof. Also, the axial-winding motor will have larger cogging torque. Therefore, it is desired to improve the above conventional axial-winding motor.

### SUMMARY OF THE INVENTION

It is therefore the primary objective of this invention to provide an axial-winding motor which has lower axial vibration and lower cogging torque.

It is the other objective of this invention to provide an axial-winding motor which has better axial stability when suffering axial vibration of a rotor thereof.

The invention discloses an axial-winding motor, which includes a stator and a rotor. The stator has a winding assembly, a first magnetic-conducting plate and a second magnetic-conducting plate. The first and second magnetic-conducting plates are coupled with two ends of the winding assembly in an axial direction of the winding assembly. The first magnetic-conducting plate includes a plurality of first pole pieces on an outer periphery thereof, and the second magnetic-conducting plate includes a plurality of second pole pieces on an outer periphery thereof. The rotor is rotatably coupled with the stator and has a plurality of magnetic pole faces facing the stator. One of the first pole pieces is at least partially overlapped with adjacent one of the second pole pieces in an axial direction of the stator.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an exploded view of a conventional axial-winding motor.

FIG. 2 shows a top view of a conventional axial-winding motor.

FIG. 3 shows an expanded view of magnetic pole faces of a rotor of the conventional axial-winding motor.

FIG. 4 shows an exploded view of an axial-winding motor according to a preferred embodiment of the invention.

FIG. 5 shows a top view of the axial-winding motor according to the preferred embodiment of the invention.

FIG. 6 shows a top view of the axial-winding motor according to another implementation of the motor.

FIG. 7 shows a top view of the axial-winding motor according to yet another implementation of the motor.

FIG. 8 shows an expanded view of magnetic pole faces of a rotor of the axial-winding motor according to the preferred embodiment of the invention.

FIG. 9 shows an expanded view of magnetic pole faces of a rotor of the axial-winding motor according to another implementation of the rotor.

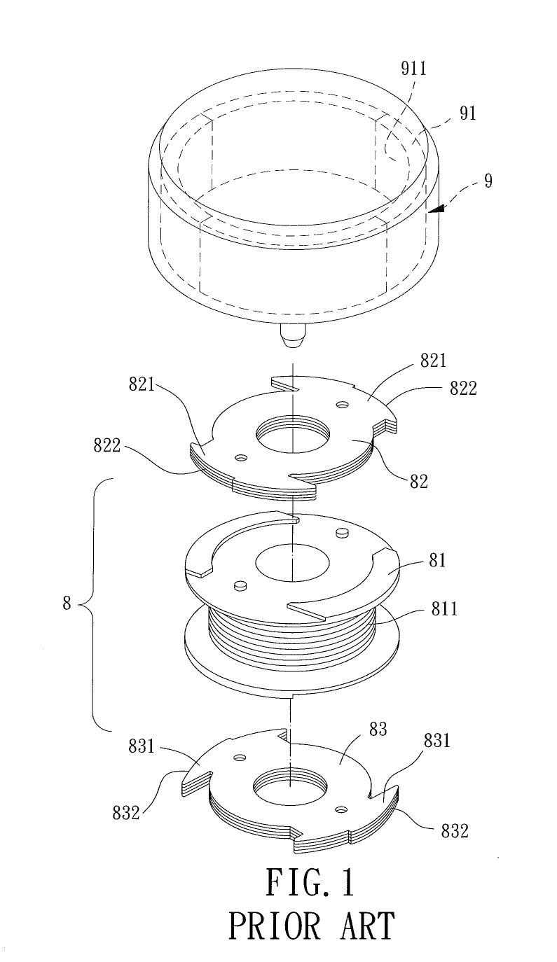

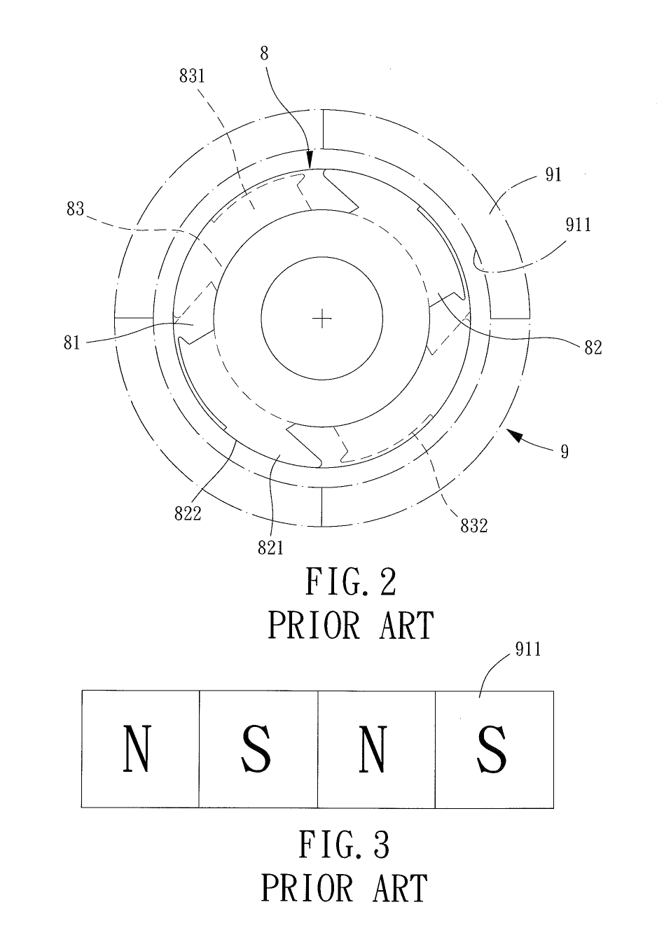

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings and are utilized only to facilitate describing the invention.

### DETAILED DESCRIPTION OF THE INVENTION

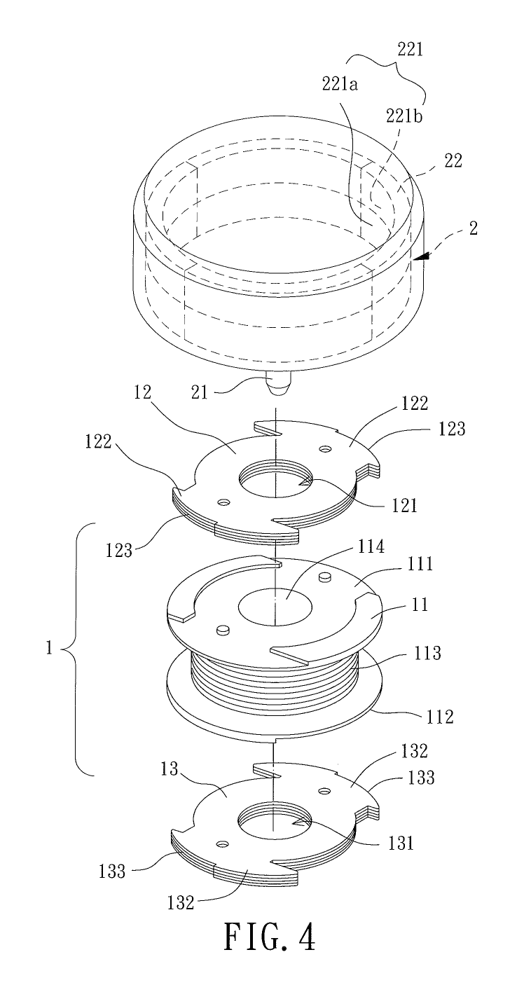

Referring to FIG. 4, an exploded view of an axial-winding motor is shown according to a preferred embodiment of the invention. The axial-winding motor includes a stator 1 and a rotor 2. The stator 1 receives currents and generates magnetic forces. The rotor 2 is disposed in accordance with the stator 1 and may be driven to rotate by the magnetic forces generated by the stator 1.

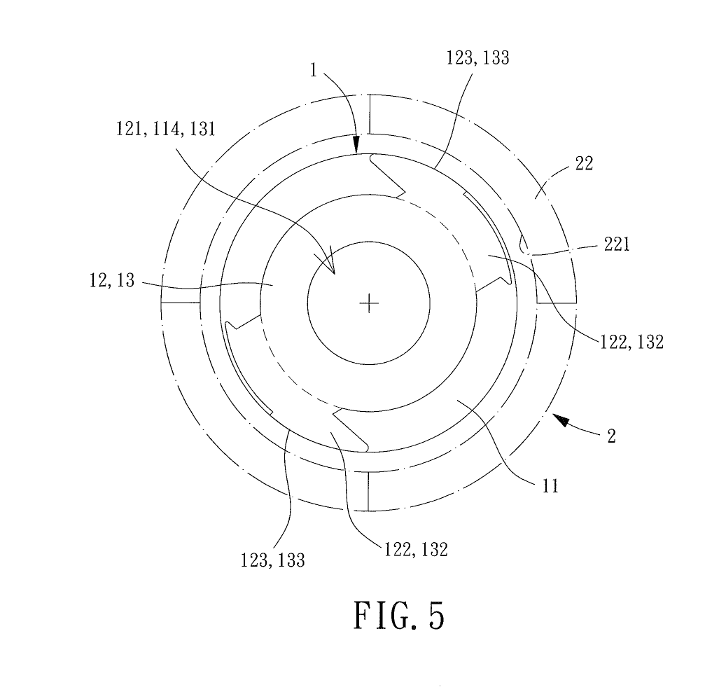

Specifically, referring to FIGS. 4 and 5, the stator 1 includes a winding assembly 11, a first magnetic-conducting plate 12 and a second magnetic-conducting plate 13. The winding assembly 11 extends in an axial direction of the stator 1 and includes a first axial face 111, a second axial face 112, a winding 113 and an axial hole 114. The first axial face 111 and the second axial face 112 are located on two ends of the winding assembly 11 in the axial direction. The winding 113 is wound around the winding assembly 11 between the first axial face 111 and the second axial face 112. The axial hole 114 extends through the first axial face 111 and the second axial face 112. The first magnetic-conducting plate 12 is coupled to the first axial face 111 of the winding assembly 11 and includes a through hole 121, a plurality of first pole pieces 122 and a plurality of first excitation faces 123. The through hole 121 extends through a center of the first magnetic-conducting plate 12 and is aligned with the axial hole 114. The first pole pieces 122 are located on an outer periphery of the first magnetic-conducting plate 12. Each first excitation face 123 is located on a respective first pole piece 122 and faces outwards. The second magnetic-conducting plate 13 is coupled to the second axial face 112 of the winding assembly 11, and includes a through hole 131, a plurality of second pole pieces 132 and a plurality of second excitation faces 133. The through hole 131 extends through a center of the second magnetic-conducting plate 13 and is aligned with the axial hole 114. The second pole pieces 132 are located on an outer periphery of the second magnetic-conducting plate 13. Each second excitation face 133 is located on a respective second pole piece 132 and faces outwards.

Referring to FIGS. 4 to 6, the rotor 2 includes a shaft 21 and a magnet 22. The shaft 21 is located on a center of the rotor 2 and extends through the through hole 121, axial hole 114 and through hole 131. The magnet 22 is disposed around the shaft 21, and includes a plurality of magnetic pole faces 221 located on an inner circumferential wall thereof and facing the stator 1.

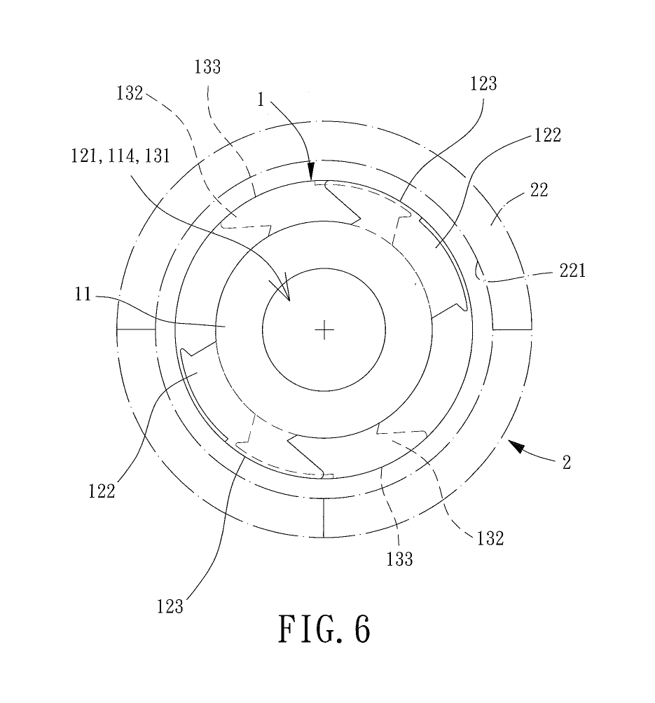

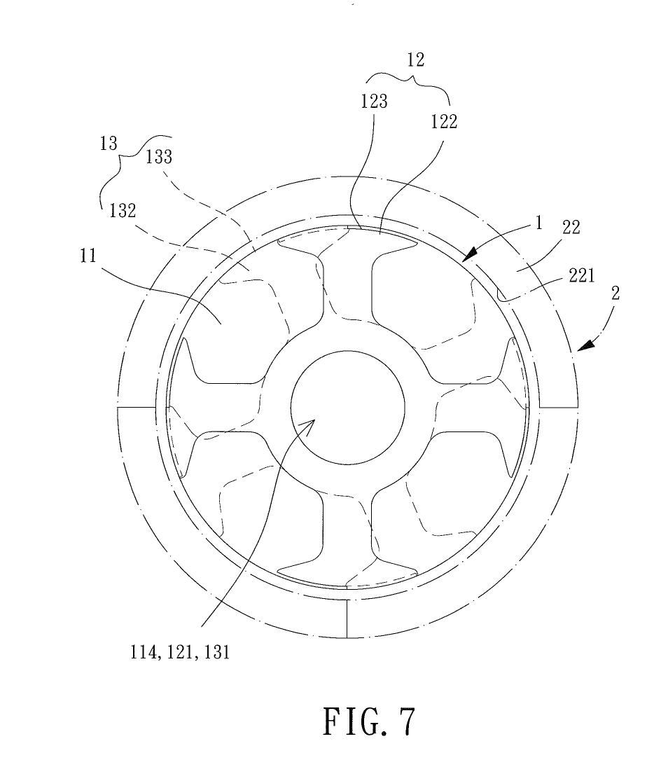

The axial-winding motor of the invention is characterized by that any first pole piece 122 is at least partially overlapped with one adjacent second pole piece 132 in the axial direction of the stator 1. In other words, take the stator 1 in FIG. 5 as an example, any first pole piece 122 is fully overlapped with one adjacent second pole piece 132 in the axial direction of the stator 1. Namely, the first magnetic-conducting plate 12 extends in parallel in the same direction as the second magnetic-conducting plate 13. Alternatively, referring to FIG. 6, any first pole piece 122 may be designed to be partially overlapped with one adjacent second pole piece 132 in the axial direction of the stator 1. In another embodiment of the stator 1 shown in FIG. 7, where four first pole pieces 122 and four second pole pieces 132 are presented, any first pole piece 122 may still be designed to be partially overlapped with one adjacent second pole piece 132 in the axial direction of the stator 1.

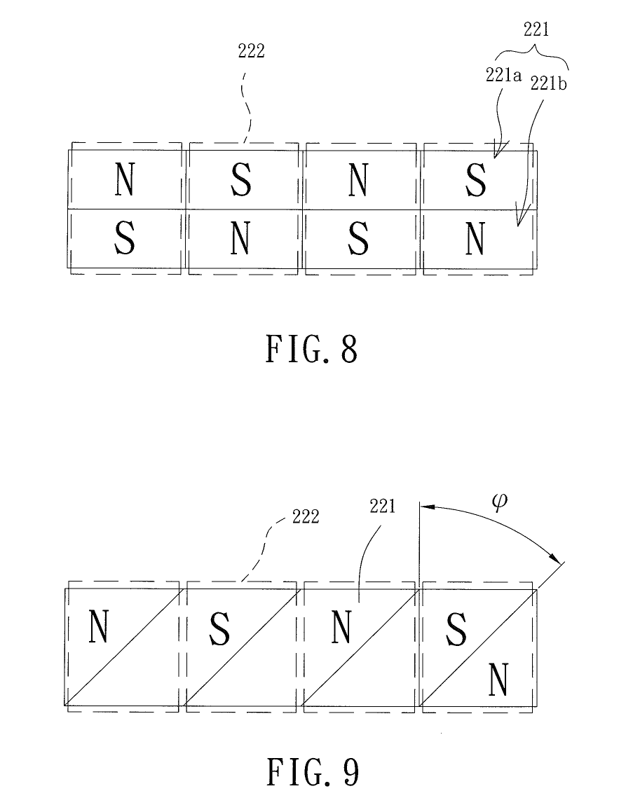

Referring to FIGS. 8 and 9, the magnetic pole faces 221 of the rotor 2 form a plurality of opposite magnetic pole areas 222 along a circumference of the rotor 2, wherein each opposite magnetic pole area 222 has at least two magnetic poles with opposite polarities. Each opposite magnetic pole area 222 is located on an inner face of the magnet 22 and extends in parallel to an axial direction of the rotor 2. In addition, each opposite magnetic pole area 222 has at least an S magnetic pole and an N magnetic pole. Specifically, the opposite magnetic pole areas 222 may be implemented in many ways. For example, as shown in FIG. 8, the magnetic pole faces 221 of the rotor 2 may form a first annular magnetic face 221a and a second annular magnetic face 221b. Both the first annular magnetic face 221a and the second annular magnetic face 221b have at least an N magnetic pole face and an S magnetic pole face. The first annular magnetic face 221a and the second annular magnetic face 221b are disposed along the axial direction of the rotor 2 so that the first annular magnetic face 221a faces the first pole pieces 122 of the first magnetic-conducting plate 12, and the second annular magnetic face 221b faces the second pole pieces 132 of the second magnetic-conducting plate 13. However, extension direction of the magnetic pole faces 221 may also be designed in a way that an inclining angle φ is formed between the extension direction of the magnetic pole faces 221 and the axial direction of the rotor 2.

In this way, since the first pole pieces 122 are at least partially overlapped with the second pole pieces 132 in the axial direction of the stator 1, an inclining angle between an extension direction of the first pole piece 122 and an extension direction of one adjacent second pole piece 132 is smaller. Thus, when a current is applied to the winding 113, an axial component of a repelling force between the first excitation faces 123 and the magnet 22 will offset an axial component of a repelling force between the second excitation faces 133 and the magnet 22. As a result, axial vibration of the rotor 2 is reduced and cogging torque is also reduced, allowing the rotor 2 to have better axial stability when suffering an axial movement.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. An axial-winding motor, comprising:
a stator having a winding assembly, a first magnetic-conducting plate and a second magnetic-conducting plate, wherein the first and second magnetic-conducting plates are coupled with two ends of the winding assembly in an axial direction of the winding assembly, the first magnetic-conducting plate includes a plurality of first pole pieces on an outer periphery thereof, and the second magnetic-conducting plate includes a plurality of second pole pieces on an outer periphery thereof; and
a rotor rotatably coupled with the stator and having a plurality of magnetic pole faces facing the stator, wherein one of the first pole pieces is at least partially overlapped with an adjacent one of the second pole pieces in an axial direction of the stator.

2. The axial-winding motor as claimed in claim 1, wherein the magnetic pole faces form a plurality of opposite magnetic pole areas along a circumference of the rotor, the opposite magnetic pole areas extend in parallel to an axial direction of the rotor, and each of the opposite magnetic pole areas includes at least an S magnetic pole face and an N magnetic pole face.

3. The axial-winding motor as claimed in claim 1, wherein the magnetic pole faces of the rotor form a first annular magnetic face and a second annular magnetic face along a circumference of the rotor, and the first annular magnetic face and the second annular magnetic face are disposed along an axial direction of the rotor.

4. The axial-winding motor as claimed in claim 2, wherein an inclining angle is formed between an extension direction of the magnetic pole faces and the axial direction of the rotor, thereby forming the plurality of opposite magnetic pole areas.

5. The axial-winding motor as claimed in claim 1, wherein one of the first pole pieces is fully overlapped with an adjacent one of the second pole pieces in the axial direction of the stator.
